(19) United States
(12) Patent Application Publication
(10) Pub. No.: US 2010/0188932 A1
(43) Pub. Date: Jul. 29, 2010

(54) Low Power Sensor System

(76) Inventors: Darwin Mitchel Hanks, Fort Collins, CO (US); Robert Allan Morain, Fort Collins, CO (US)

Correspondence Address: Darwin Mitchel Hanks, 3706 Ashmount Drive, Fort Collins, CO, 80525, US

(21) Appl. No.: 12/361,535

(22) Filed: Jan. 28, 2009

(51) Int. Cl. B06B 1/00

(52) U.S. Cl. 367/140

(57) ABSTRACT

A sensor for a vehicle that conserves power by alternately switching between a power on and a reduced power state. The circuit compares a most recent sensor measurement with an earlier measurement while in the power-on state and then switches to a reduced power state. A time delay generation function determines when the circuit switches out of the reduced power state depending on the result of the comparison. The duration of the reduced power state can be increased depending on the similarity of the most recent measurement to an earlier measurement.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISK APPENDIX

Not applicable

### BACKGROUND OF THE INVENTION

Ultrasonic transducers are useful for detecting proximity. Proximity, or the distance from an ultrasonic transducer to an object, is detected by measuring the time it takes for a sound wave produced by the transducer to travel to the object, reflect off the object, and travel back to the transducer. Ultrasonic transducers are used in a variety of applications. One example application is in medical ultrasound imaging systems where ultrasonic sound waves are used to detect surfaces and objects inside the body such as a developing fetus. Ultrasonic transducers act as reciprocal devices, meaning that they can both transmit ultrasonic sound waves and receive or sense ultrasonic sound waves. Ultrasonic transducers transmit ultrasonic sound when their electrical leads are driven by a voltage varying at an ultrasonic frequency. These transducers receive or sense ultrasonic sound when soundwaves impact their face, producing mechanical vibrations which are then converted to electrical voltage or current variations on their electrical leads. Thus, a sensor which is based on an ultrasonic transducer is used to sense objects in its environment by issuing an ultrasonic excitation (soundwave pattern) from the transducer and then using the same transducer to detect returning echos. An ultrasonic transducer is part of a sensor system which controls the issuing of excitations and the reception and interpretation of returning echoes.

Recently vehicle manufacturers have begun installing ultrasonic transducers in vehicles to detect objects in the path of the vehicle when it is backing up. Typically four transducers will be mounted with even spacing across the rear bumper of a car so that when backing up these transducers can detect whether obstacles lie in the path by issuing an ultrasonic sound pattern and detecting echoes of the sound pattern from such objects. These ‘parking sensors’ appear to be gaining in popularity and are seen in an increasing number of new vehicles.

Because of the ability of these parking sensors to aid the driver in detecting obstacles in the path behind the vehicle and consequently decrease the probability of accidentally backing into another car or backing over a bike, animal or even a child, there has been increased interest in making parking sensor technology available to owners of older vehicles that were not originally equipped with such parking sensors. Parking sensor kits are offered that provide four or more ultrasonic transducers that can be mounted into the bumper of a user's vehicle by measuring and drilling four holes in the bumper into which the transducers are mounted. Wiring is then routed into the interior of the vehicle to a control module that is powered by the vehicle's electrical system and which also powers a display or audible warning transducer that signals the user whether an obstacle is behind the vehicle. Although this device can accomplish the desired purpose of sensing objects behind the vehicle, many potential customers of this style of device are deterred by the difficulty and risks associated with drilling and mounting the transducers into the bumper. A car owner does not want to accidentally drill a hole in the wrong location or drill a hole of the wrong size. In order to avoid this customer deterrent, some parking sensors use the vehicle's license plate installation receptacles to mount a bracket over and around the license plate that holds one or more ultrasonic transducers and possibly a camera. Design Pat. No. D0411499 and U.S. Pat. No. 7,379,389 illustrate such a device. This license-plate mounted bracket holds the transducers at angles to sense most of the area behind the vehicle and avoids the need to mount the transducers directly into the vehicle itself. The license plate mounted scheme overcomes the concerns associated with drilling holes in the bumper. Still, it is necessary to route cables from the transducers into the interior of the vehicle and to connect these to the vehicle's electrical system. Whether the transducers are mounted in the bumper directly or in a license plate frame, the transducers are typically powered by connecting the transducer control module power supply wires to the reverse light wires of the vehicle. This is done so that the sensor system is only powered on when the car is in reverse and potentially moving in a direction where obstacles behind the vehicle are a concern. When the car is parked or moving forward the sensor system is disabled thus reducing the likelihood of false warnings from situations where a backover is unlikely.

Thus, a characteristic of conventional parking sensors is that they require difficult mounting procedures including the routing of wiring from the exterior of the vehicle to the interior of the vehicle and locating and connecting electrically to power carrying lines within the vehicle.

An additional characteristic of some parking sensors is that they require the measurement and drilling of holes in the vehicle's bumper to install transducers.

Accordingly, there is a need for an apparatus and method of sensing obstacles behind a vehicle that can be installed more easily and conveniently and without the aid of specialized technicians.

One way to avoid the issue of routing wires from the outside of the car to the interior of the car and of finding and successfully connecting the power supply wires of the parking sensor to the reverse light power wires of the car is to build the sensor circuitry and a battery or small power source directly into the assembly that houses the transducers and to communicate the sensor result wirelessly. In U.S. Pat. No. 7,385,485, Thomas et al. teach of using a battery powered tire pressure sensor mounted inside each tire that communicates wirelessly with an in-vehicle control module that is mounted inside the car. In such battery powered sensor applications it is important to conserve battery power by minimizing the power drawn by the sensor circuit. This is important because changing or recharging the battery or power source is time consuming and often requires partial disassembly of the sensor enclosure to access the battery or power source. A drained battery or power source also results in loss of functionality of the sensor circuit until the battery is replaced or recharged or the power source is replenished. Consequently, it is of significant advantage to minimize the power consumption associated with sensor circuitry to lessen the frequency of the need to recharge or replace the power source.

Thomas et al. teach a method of sensing the tire pressure and transmitting the result at pre-determined intervals and of powering the sensor circuitry down to a low-power state while not sensing and transmitting in order to conserve battery power. They further teach having the in-vehicle control module transmit to the sensor control module the time interval between sensing and transmitting cycles. By reducing the amount of time the tire pressure sensing circuitry is operational and shutting down portions of the circuitry for a significant percentage of the time, battery power can be conserved and the sensor function will operate for a longer duration than if it were always on. In the example of a tire pressure monitoring system, it would be useful to be able to program the tire pressure sensors to remain off for significantly longer periods of time when the car is not in use so as to not waste power on tire pressure measurements at such times.

The invention of Thomas et al. highlights the interest in conserving as much power as possible in order to make the battery last as long as possible for reasons earlier mentioned. Their invention teaches making the time interval between sensing and transmitting cycles wirelessly programmable so that the in-vehicle control module can optimize in each of the tire pressure sensing modules the tradeoff of sensing rate versus power drain of the battery. This method requires the additional functionality of a wireless receiver to be built into the tire pressure sensing module which adds to the size requirements of the device, to the power requirements of the sensor circuitry and also to the cost. Additionally, a transmitter module must be added to the vehicle control module which adds cost.

U.S. Pat. No. 6,098,118 by Ellenby et al. teaches sensing physical properties of the electronic device itself to detect when a change in the position and/or attitude of the device has occurred that warrants a change in mode of operation of the device. There is no need in this case to receive transmissions from a central control module to optimize the tradeoff of sensing versus power drain because the sensor module itself determines when it is in use. This invention is useful to a device that is active when its own physical properties such as position and attitude are undergoing change as would be the case with an electronic viewing device when a user picks up the device and uses it to assist in the observation of a sporting event. The invention does not help in a case where the device is stationary or when physical properties it is intended to sense are separate and apart from it such as would be the case if a car with a parking sensor is stationary and preparing to back up when another car or animal or person moves into the pathway of the car, or when the car is backing up and approaches an object.

Thus, it is a characteristic of some battery powered sensor devices that they monitor their own physical properties of position and attitude to determine mode of operation.

It is a characteristic of some battery powered sensor devices that they require the additional expense of communication circuitry to communicate sensed data to a separate control module which then communicates back to the sensor device to determine its mode of operation.

Accordingly, there is a need for a battery powered sensor device that can optimize the sensing of its surroundings versus power drain without additional communication circuitry.

### BRIEF SUMMARY OF THE INVENTION

The following presents a simplified summary in order to provide a basic understanding of one or more aspects of the invention. This summary is not an extensive overview of the invention, and is neither intended to identify key or critical elements of the invention, nor to delineate the scope thereof. Rather, the primary purpose of the summary is to present some concepts of the invention in a simplified form as a prelude to the more detailed description that is presented later. The present invention is directed to a system and method of sensing the surroundings of a vehicle.

In accordance with one embodiment of the invention, a method for controlling power consumption in a system that senses the surroundings of a vehicle is disclosed. The method includes the steps of sensing a physical property of the surroundings and determining from the sensed physical property a duration of a sleep state. In one embodiment the sensor could be an ultrasonic transducer. In one embodiment the sensor could be a motion detector. In one embodiment the duration of the sleep state could be determined by a digital count value. In accordance with one embodiment the duration of the sleep state could be determined by comparing at least a first value derived from the sensed physical property to at least a second value derived from at least one earlier sensed physical property. In one embodiment the duration of the sleep state could be determined to be longer if a first value derived from a sensed physical property is similar to a second value derived from an earlier sensed physical property.

In accordance with one embodiment of the invention, a system for repeatedly sensing the environment of a vehicle and then operating in a low power consumption mode is disclosed. The system for sensing the surroundings of a vehicle comprises a sensor, a power supply, an antenna, and a control module wherein the control module uses a characteristic of a signal from the sensor to determine a rate at which to sense the environment. In one embodiment the sensor is an ultrasonic transducer. In one embodiment the sensor transmits an ultrasonic sound wave and receives at least one ultrasonic sound wave that is an echo of the transmitted sound wave. In one embodiment the rate at which the environment is sensed is determined by a digital timer. In one embodiment the power supply includes a battery. In one embodiment the power supply includes a solar cell. In one embodiment the antenna transmits a signal that is received by a receiver that is inside the vehicle.

In accordance with another embodiment of the present invention, a method for controlling an electronic device is disclosed. The method includes the steps of sensing a characteristic of the environment external to the device, comparing a representation of the sensed characteristic with at least one stored representation of at least one earlier sensed characteristic of the environment, and changing from a first mode of operation to a second mode of operation depending on the result of said comparison. In one embodiment the first mode of operation operates at a different level of average power consumption than the second mode of operation. In one embodiment the first mode of operation operates with a different type of communication to a Human Interface Device than a second mode of operation. In one embodiment the Human Interface Device includes a display. In one embodiment the Human Interface Device includes an audio transducer. In one embodiment the stored representation is a function of a plurality of earlier measurements.

### BRIEF DESCRIPTION OF THE DRAWINGS

FIG. 1 shows a block diagram of a system for sensing the surroundings of a vehicle.

FIG. 2 shows a diagram of a circuit for driving a transducer wherein the driver functions can be disabled (tri-stated) to allow the transducer to detect signals and pass these to a sensor amplifier.

FIG. 3 shows a diagram of a system for sensing the surroundings of a vehicle as it is used with a vehicle to sense obstacles near the vehicle.

FIG. 4 shows a flow diagram illustrating an embodiment of the invention.

FIG. 5 shows a flow diagram illustrating an embodiment of the invention.

FIG. 6 shows a flow diagram for the echo detection sequence.

FIG. 7 shows a flow diagram for the preparation for sleep mode.

### DETAILED DESCRIPTION OF THE PREFERRED EMBODIMENT

An embodiment of the present invention comprises a novel system for improving the performance of electronic devices and related methods. The following description is presented to enable a person skilled in the art to make and use the invention. Descriptions of specific embodiments are provided only as examples. Various modifications to the preferred embodiments will be readily apparent to those skilled in the art, and general principles defined herein may be applied to other embodiments and applications without departing from the spirit and scope of the invention. Thus, the present invention is not intended to be limited to the embodiments disclosed, but is to be accorded the widest scope consistent with the principles and features disclosed herein.

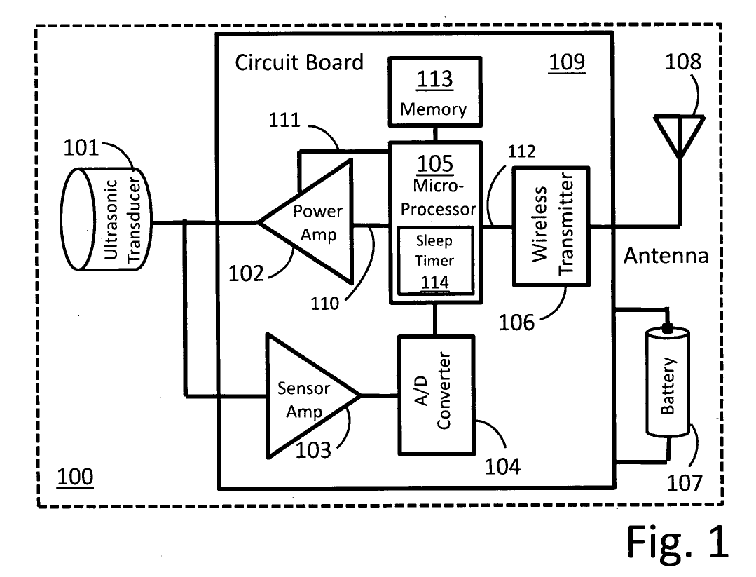

An embodiment of the invention herein described is a parking sensor that is simpler to install because the installer does not have to drill holes or route wires from the exterior to the interior of the car and make connections to other wires in the car. FIG. 1 illustrates a block diagram of a first embodiment of the parking sensor system 100. System 100 monitors the physical properties of its surroundings through the use of an ultrasonic transducer 101. Printed circuit board 109 supports circuitry used to control and monitor the transducer 101. Microprocessor 105 controls the operation of the overall system as would be found in a typical small embedded system as understood by those familiar with the art. The microprocessor toggles microprocessor pin 110 at a 40 kHz rate for a short period of time to produce a 40 kHz excitation signal. In one embodiment the microprocessor toggles the pin 110 between its high and low states 16 times to produce 16 cycles of a 40 kHz burst. An ultrasonic transducer preferred for use in parking sensor systems typically operates with maximum efficiency at a 40 kHz excitation rate, on account of its mechanical resonance at that frequency. Thus the sensor system will produce optimum results if energy at or near the frequency of 40 kHz is applied. The excitation signal is converted to a low impedance drive signal by the power amplifier 102 which is capable of providing the current needed to drive ultrasonic transducer 101 mechanically. As the ultrasonic transducer 101 vibrates mechanically as a result of the electrical excitation signal, sound waves are produced that radiate away from the transducer 101. In other words, the ultrasonic transducer 101 acts similar to a loudspeaker capable of operating at ultrasonic frequencies. Because the ultrasonic resonant frequency at 40 kHz acts as a mechanical tuned circuit, it will amplify excitations at or near 40 kHz and filter out other frequencies. Thus, even though the microprocessor pin 110 is a digital signal that changes between a high and low voltage, resulting in a squarewave waveform that has harmonic frequencies above 40 kHz, the transducer does not respond significantly to the higher harmonics and responds with sinusoidal motion at the pin's toggle rate producing a sinusoidal burst of ultrasonic sound. After issuing the ultrasonic excitation signal, the microprocessor 105 disables power amplifier 102 which causes the power amplifier output to be in a high impedance state so as not to load the transducer as the microprocessor 105 begins to ‘listen’ for an echo by sampling the output of the sensor amplifier 103 through analog to digital converter 104. Sensor amplifier 103 is a voltage amplifier that amplifies the small voltage fluctuations produced by the transducer when it senses ultrasonic echos of the transmitted soundwave. The amplified signals are large enough in amplitude to span a portion of the operating range of the analog to digital converter 104. Analog to digital converter 104 converts the amplified voltage signal received by the transducer to digital numbers readable by the microprocessor 105 as will be understood by those familiar with the art.

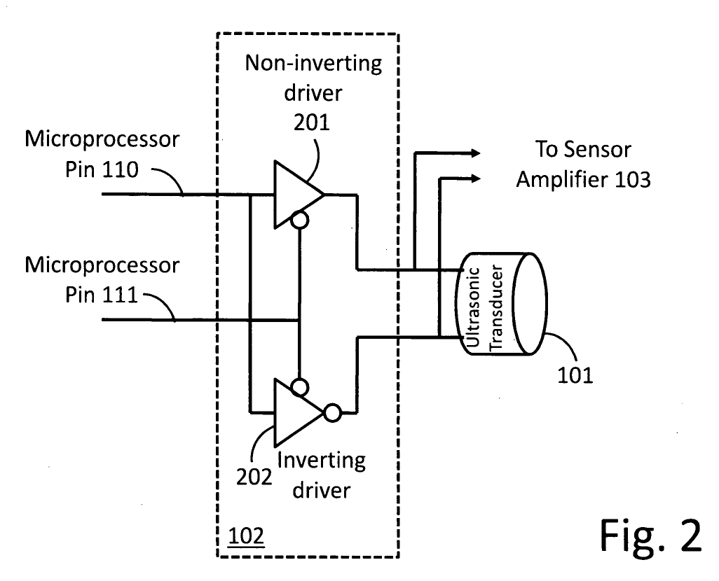

As mentioned above, the power amplifier 102 can be disabled such that it does not load the transducer with a low impedance during the time when the transducer is detecting the echo of the ultrasonic excitation. FIG. 2 illustrates one embodiment of the power amplifier which includes an inverting CMOS driver 202 such as the CMOS logic device 74ACT240 and a non inverting CMOS driver 201 such as the CMOS logic device 74ACT244. When the drivers are enabled, as is the case when microprocessor pin 111 is in the high state, the outputs of driver 201 and 202 are in a low impedance state. As pin 110 from the microprocessor is brought high, the output of driver 201 is driven high while the output of driver 202 is driven low. As pin 110 is brought low, the outputs of drivers 201 and 202 reverse their polarities. Thus, as microprocessor pin 110 is toggled, the two sides of the transducer, connected to drivers 201 and 202 respectively, are driven differentially. When microprocessor pin 111 is brought to the low state, the outputs of drivers 201 and 202 are disabled, going to a high impedance state. In this condition small voltages produced by the transducer in response to ultrasonic sound waves detected will pass to the sensor amplifier without being loaded by the drivers. In FIG. 1 the output of the power amplifier 102 and the input of the sensor amplifier 103 are shown as connected to the ultrasonic transducer 101 with a single wire for the sake of simplicity and generality of the drawing. In the embodiment of FIG. 2 these connections are shown to be differential.

The microprocessor has access to memory 113 which it can use to store and retrieve characteristics of measurements for comparison to later measurements, as will be described later. The microprocessor also has a sleep timer 114 function which can be found in many microprocessors commonly available and with which those knowledgeable in the art are familiar. The microprocessor can program a count value, or sleep duration into the sleep counter, and then reduce its power consumption to very low levels while waiting for the sleep counter to complete its count. When the sleep counter reaches a termination count (‘0000’ for example) the microprocessor is enabled to bring its circuitry back to higher levels of functionality and power consumption.

In one embodiment the system 100 is powered by a battery 107, as illustrated in FIG. 1. In another embodiment a solar cell could be added along with a battery charging circuit and rechargeable battery such that the battery would not have to be replaced so long as sufficient solar energy was collected by the solar cell. Other embodiments of the power supply for the system might include a large value capacitor with a solar cell, a fuel cell, or other power supply technologies.

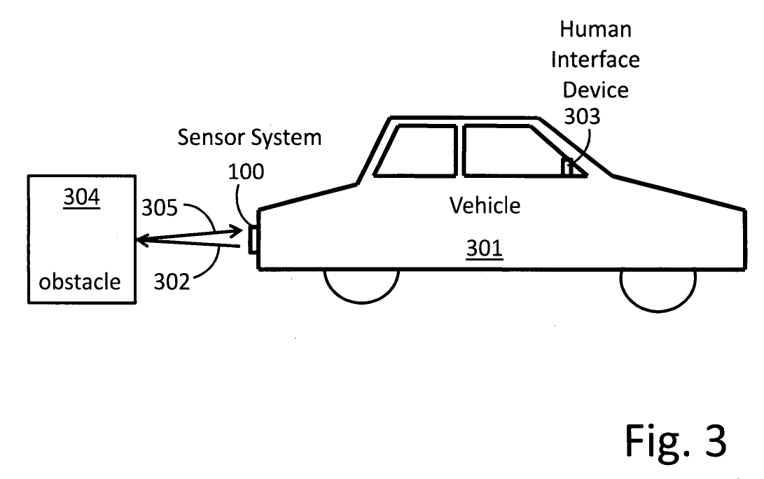

FIG. 3 illustrates the parking sensor system as it would be installed on the back of a vehicle 301. As incident sound waves radiate outward 302 from the sensor system 100, an obstacle 304 in the path of the sound waves reflects the sound waves 305 back toward the transducer 101 that is part of the sensor system 100. Sound waves that have been reflected off of an obstacle or surface back toward the source of the sound waves are often called the ‘echo’ of the incident sound waves. Sound waves 305 reaching the transducer 101 cause mechanical motion of the transducer face which are converted into electrical signals, as the transducer 101, being a reciprocal device, converts mechanical energy into electrical energy in addition to being able to convert electrical energy into mechanical energy, as mentioned above. These electrical voltage signals are amplified by the sensor amplifier 103, which is also connected to the transducer 101, to produce an amplified signal. The amplified signal is sent to analog to digital converter 104 which the microprocessor 105 uses to convert the amplified signal of the transducer 101 to digital numbers that they can be used by the microprocessor to determine characteristics about the received signal.

The ultrasonic transducer system 100 measures proximity of the object off which the outgoing sound wave 302 was reflected by measuring the time between when the excitation (outgoing ultrasonic soundwave 302) was generated by the microprocessor and when an echo (reflected soundwave 305) is detected. Because sound travels a nominal 13661 inches/second and the time between excitation and echo is the time for the sound wave to travel round trip from the transducer to the reflecting object and back, the conversion factor to calculate distance from round trip time is

Distance from transducer to obstacle=6.83 inches/millisecond.

Because microprocessors are typically clocked by an oscillator that is referenced to a crystal the microprocessor can accurately measure time by counting cycles of the oscillator. By counting oscillator cycles or instruction cycles (which are based on oscillator cycles) between the excitation output and the time where the microprocessor detects the returning echo, the microprocessor can accurately determine the time between the excitation and the detected echo and then by using the equation above it can determine distance. If, for example, the microprocessor operates with an instruction cycle of 0.25 microsecond (0.00025 millisecond) and the microprocessor issues an excitation and then counts 30000 instruction cycles before an echo is detected, it would determine that the reflecting object is 30000 instruction cycles*0.00025 millisecond/instruction cycle*6.83 inches/millisecond=51 inches away.

In an embodiment of the inventive parking sensor system there is a wireless connection between the transducer circuit 100 and a human interface device 303 such as a display or audible transducer. Consequently, once the microprocessor 105 detects an echo from an object within its range and determines the number of instruction cycles executed between excitation and detected echo, it can send this count or information derived from the count to the human interface to signal a driver that an obstacle has been detected and how far away it is. This is done by transmitting this information wirelessly via wireless transmitter 106 and antenna 108 to a receiving antenna and wireless receiver inside the vehicle that is connected to the display or audible transducer. There are several well known wireless transmission and reception technologies that could here be successfully used. In one embodiment, an FM transmitter designed to transmit within the FM radio band (87.5 to 108.0 MHz) is modulated using signals produced by the microprocessor. In this embodiment, microprocessor 105 toggles a microprocessor pin 112 at a frequency within the range of human hearing. This toggling occurs in bursts of several hundred cycles interspersed with periods where the microprocessor pin 112 is quiet and remains at one level without toggling. The frequency at which the microprocessor pin is toggled during the burst will be referred to as the burst frequency and the frequency of the cycle between burst and silence will be called burst repetition rate. If the microprocessor pin were to be connected to an amplifier and loudspeaker one would hear a tone regularly interrupted by silence—a ‘beep, beep, beep’ pattern. Because the microprocessor pin is connected to the modulating input of the FM transmitter, it causes a frequency modulation of the FM transmitter's carrier frequency which in turn drives the antenna which radiates the FM modulated periodic burst signal. The vehicle's radio, when tuned to the carrier frequency of the FM transmitter, serves as a Human Interface Device 303 and receives and demodulates the transmitted signal to recover the audio band periodic burst signal (‘beep, beep, beep’ is heard on the car's speakers that are connected to the FM radio system). The microprocessor can communicate the distance that the detected obstacle is from the parking sensor by changing the repetition rate of the burst. For example, if the detected obstacle is a relatively long distance away, the repetition rate would be slow with perhaps a second or more between tone bursts (beeps). As the obstacle draws nearer the repetition rate would increase with tones (beeps) occurring at a more rapid rate.

Other wireless methods could be employed to communicate presence and distance of an obstacle from the parking sensor to a Human Interface Device 303 inside the vehicle. For example, an AM band carrier could be amplitude modulated to drive an antenna and this signal then picked up by the car's AM radio. Alternatively, a wireless digital communication standard such as Bluetooth or Zigbee could be employed to communicate distance to an interior wireless receiver which could then be displayed or audibly registered. Proprietary, non-standard transmission standards could also be successfully employed. Each of these approaches avoids the necessity of routing wires from the parking sensor into the interior of the car and simplifies installation.

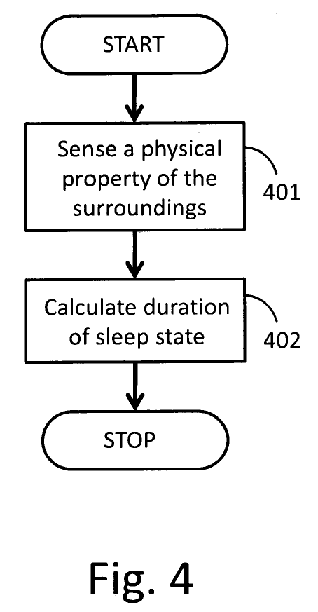

A key aspect of an embodiment of the invention is a system and method for reducing power drain from the sensor system's power source. FIG. 4 illustrates one embodiment which involves the steps of sensing a physical property of the surroundings (401) and then determining the duration whereby the system will remain in a sleep state (402). Because power is conserved while the system is in the sleep state, the system can determine from a characteristic of the physical property being sensed whether to perform frequent sensings and remain in the sleep state for a short amount of time between sensings, or to remain in the sleep state for a longer duration and perform sensings less frequently.

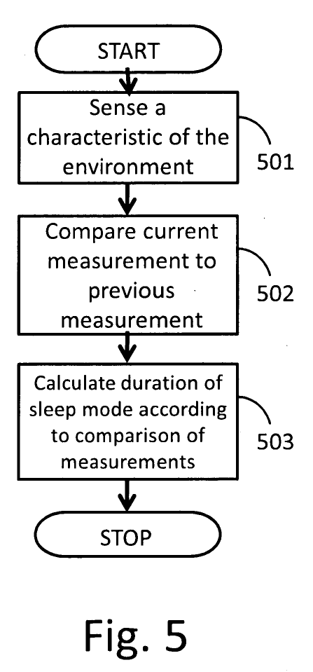

FIG. 5 illustrates an embodiment where after sensing a characteristic of the environment (501) the sensor compares a representation of the sensed result with the result of a previous measurement (502) and determines from the result of this comparison the duration that the system will remain in a sleep mode (503).

In one embodiment of the invention, in order to reduce the drain of the power source, the microprocessor detects whether a new obstacle is present or not and sets a delay amount that determines how long the control system will remain in a sleep, or low power mode before awakening, or leaving the low power state, to make the next distance detection measurement. In order to conserve power, the sensor system 100 is designed to be on only as long as is needed to detect the proximity of any obstacles within the sensor's range and to transmit this information to a human interface device such as a display or audible warning device. The rate at which it performs this function is designed to be sufficiently often to provide sufficient warning for the vehicle driver to respond before a collision occurs. When a distance detection cycle has been completed, the microprocessor turns off all unneeded circuitry including most of its own functions and goes into a low power, or ‘sleep’ mode of operation. While in this sleep mode, the microprocessor relies on some timekeeping function to wait a delay amount following which the microprocessor exits the sleep mode, turns back on the needed circuitry and performs operations associated with a new distance detection cycle. In one embodiment this timekeeping function is a timer associated with the microprocessor and the duration of the sleep state is determined by a timer count that is programmed into the timer. After the microprocessor goes into the sleep mode this timer counts down until it reaches a count of zero, at which time logic associated with the timer signals the microprocessor to ‘wake up’ and exit the sleep mode. Normally the repetition rate for going through the distance detection cycle of issuing an excitation, sampling the echo, transmitting any results to the human interface device, and entering a sleep mode can be equal to or greater than one cycle per second. If the system detects an object within its detection range, however, it means that a new object has been detected within the detection range of the sensor, which for a typical parking sensor system is on the order of six feet. With the object at a distance of six feet or more, there is plenty of time under normal backing conditions to warn the driver of impending collision if the detection rate is one second. However, as the distance from the object decreases, the need to increase the distance detection rate arises in order that the driver will be warned sufficiently before risking a collision. The adjustment of the duration of the sleep state as a function of a change in detected surroundings is a key aspect of an embodiment of the invention and a preferred method will be explained as follows.

In order to detect changes in the surroundings, the sensor system compares the most recent sensor result with earlier results. While sampling the output of the sensor amplifier 103 through the analog to digital converter 104, the microprocessor compares these samples for each sample time since the excitation was issued to a value stored earlier that is a function of earlier samples. In one embodiment, this stored value is a ‘running average’ of earlier samples according to the following equation:

Dₖ=Pₖ(1−γ)+D′ₖγ

where k is the sample index, Dₖ is the running average, Pₖ is the most recent sample, D′ₖ is the previous running average, and γ is the decay rate of the running average. In one embodiment, a sample is taken every 25 microprocessor instruction cycles and the instruction cycle period is 0.25 microseconds as in the earlier microprocessor example. In this embodiment, then, the resolution of the sampling is 6.25 microseconds or 0.043 inches of distance per sample. This means that the processor samples (through the analog to digital converter) the amplified transducer signal 1674 times after issuing an excitation in order to be able to detect an object that is up to 6 feet away. For the first sample after the excitation signal has been issued the sample index k is equal to 1. For the next sample, k equals 2 and so forth until the last sample where k equals 1674. In one embodiment the running average is stored for each sample time k such that there are 1674 different stored running average values, each corresponding to a different proximity distance ranging from 0 inches to 72 inches (6 feet). Alternative embodiments may economize on memory and processing by sampling at a lower rate, by combining samples at the higher sample rate through detection of a peak value and conversion to a lower sample rate or by more complex algorithms such as applying a matched filter, maximum likelihood sequence detection algorithm or other communication channel algorithm to detect a reflected signal within a group of samples and then preserving only an indication of the degree to which an echo was detected for every N samples, where N is a submultiple of the overall samples taken. Regardless of the scheme, the result is an array of values representing the relative echo activity detected at each position increment between the transducer and the end of the range of detection capability. In the above embodiment where there are 1674 values representing the amplitude of the echo signal for increments of 0.043 inch over a range of 6 feet (72 inches), if there is an object approximately 5 feet away, there would be an echo from the obstacle that would appear as a non-zero voltage in the amplified transducer output at the k=5*12/0.043=1395^{th} sample. Thus, Pₖ₌₁₃₉₅ would return a non-zero value corresponding to the amplitude of the detected and amplified echo off the object. If this is the first detection of the object (the object is newly within detection range of the transducer), the running average value Dₖ₌₁₃₉₅ would be approximately equal to zero (approximate because there may be a small level of noise in the system). The microprocessor compares the latest transducer output sample Pₖ₌₁₃₉₅ to the running average value Dₖ₌₁₃₉₅ by taking the magnitude of the difference of these and then checking whether the magnitude of the difference between the two is greater than a predetermined threshold:

If |Pₖ−Dₖ|>K_{T} Then FLAG_{ObjDetected}=TRUE

where K_{T} is an echo detection threshold that is chosen to reduce the sensitivity of the echo detection system to noise. If the magnitude of the difference is larger than the echo detection threshold, the microprocessor registers the detection of an object by setting a flag (FLAG_{ObjDetected}=TRUE) and the sample index (k=1395 in this example), from which can be calculated the distance, is recorded in memory. As the sampling sequence from k=1 to 1674 is repeated and the object at sample time k=1395 remains stationary, the running average value Dₖ₌₁₃₉₅ changes gradually from 0 to the value that the echo from that object persistently results in at the output of the analog to digital converter until Pₖ₌₁₃₉₅≅Dₖ₌₁₃₉₅. At this point the difference between the magnitudes of the two is no longer greater than K_{T} and equals zero or something close thereto. Consequently, the object at the echo time corresponding to k=1395 is no longer registered as a detected object by the system and is ignored (FLAG_{ObjDetected} is not set).

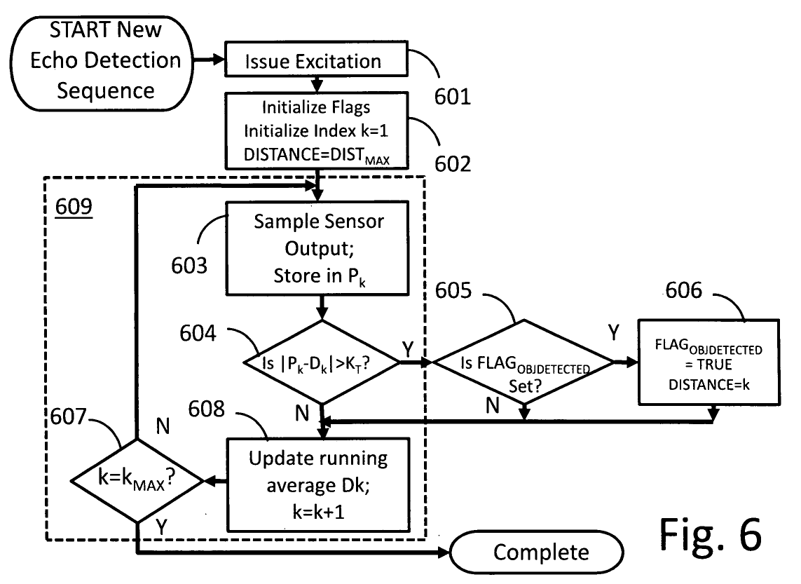

FIG. 6 shows a flow chart that aids in understanding the above preferred process for detecting an echo. After an excitation has been issued (601) key variables are initialized (602) including the flag used to signal that an echo has been detected (FLAG_{ObjDetected}), a holder for the distance at which the first echo was detected (DISTANCE), and the distance index (k). A loop (609) is then executed wherein for each pass through the loop a new sample of the transducer waveform is taken and stored in memory (603). The value of this latest sample is compared against the last running average value (604) and if the difference between the latest sample and the running average value is greater than the echo detection threshold K_{T} the FLAG_{ObjDetected} is checked to see whether this is the first echo detected (605). If it is (meaning the flag is not set), the flag is set and the distance index k is recorded in DISTANCE (606). The running average is then updated with the latest sample and the distance index k is incremented in preparation for the next time through the loop (608). If k equals its maximum value the loop is exited and the echo detection process is complete (607). This algorithm for responding to and detecting objects that are newly within the range of the transducer 101 or which have moved from the position where they were last detected to a new position within the range of the transducer 101 is sufficient for warning a driver that an object is behind the vehicle, yet it provides two advantages. The first advantage is that objects that are always within the detection range of the sensor but which are not objects that are in danger of being backed into or over will be ignored. An example of such an object is a spare tire mounted on the back of the car near the parking sensor. Such an object may be within the detection range of the sensor but since it is mounted on the car runs no risk of being backed over. Because the spare tire is only in a part of the detection field of the sensor, the sensor still can be used to detect other objects and the spare tire will not register as a detected object.

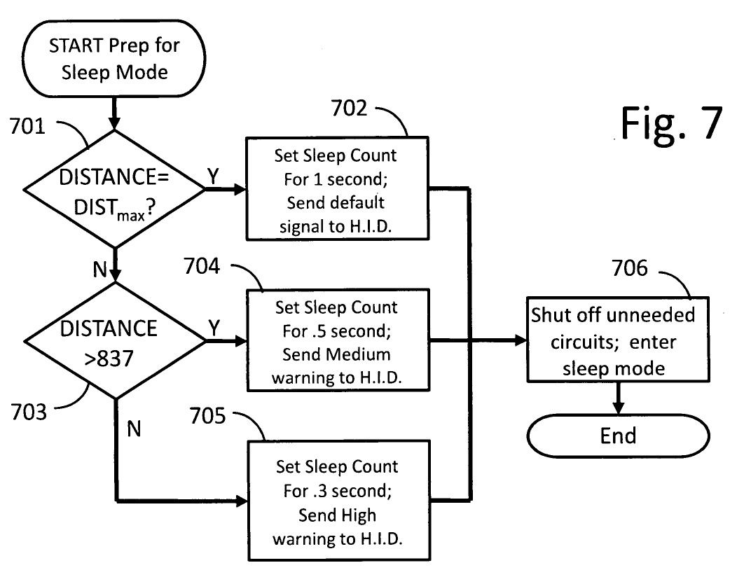

A second advantage of the use of a running average or other function of earlier sample values is for the reduction of power drain of the power source. If no new or moving objects are detected within the detection range by the parking sensor, which would be the case most of the time as the car is either parked or being driven, the rate at which the microprocessor goes through the distance detection cycle of issuing an excitation and sampling the echo can be slowed. In one embodiment the microprocessor issues an excitation and samples the echo, and if there are no new or moving objects detected within the range of the sensor (meaning that the running average Dₖ equals or approximates the current sample Pₖ for all k), then the microprocessor sets the sleep duration to be equal to one second. In one embodiment this duration is a count value that is programmed into a counter in the microprocessor's peripheral set. After the microprocessor has completed all the tasks associated with the issuing of the excitation, the sampling of the amplified transducer signal and searching for an echo, and transmitting corresponding results to the human interface device, it programs the sleep counter with the duration corresponding to what was detected during the detection cycle, as illustrated in the flow diagram of FIG. 7. If no object was detected, the distance variable remains at maximum (701), a maximum delay (1 second) is programmed into the sleep counter and a default signal is sent to the human interface device (702). The default signal causes the human interface device to register only that the parking sensor is operational. In an embodiment where there is both a display and audio transducer, the audio transducer remains quiet and the display displays ‘- -’ in response to the default signal. If an object was detected that is further than 3 feet away but less than 6 feet away (703), a shorter delay amount (0.5 seconds) is programmed into the sleep counter and a medium warning signal is sent to the human interface device (yellow bars on the display light up and a beep at a rate of 2 Hz is heard) (704). If an object was detected less than 3 feet away, an even shorter delay amount (0.3 seconds) is programmed into the sleep counter and a high warning signal is sent (red bars on the display light up and a beep at a rate of 3.3 Hz is heard) (705). In each case (702, 704, or 705) after the delay amount is programmed into the sleep counter and communications have been sent to the Human Interface Device, the microprocessor shuts off all unneeded circuitry, including most of its own circuitry, and enters a low power sleep state where a counter counts down the programmed sleep duration. When the counter reaches a termination count (for example, ‘0000’), the sleep state is exited, the microprocessor resumes full control and turns on needed circuitry to prepare for the next measurement cycle.

The repetition rate of the distance detection sequence is increased as the distance between the sensor and an object becomes smaller. This also means that as an object comes closer to the sensor, power is consumed at a faster rate by the sensor. If the object or objects detected by the sensor reach a point where they remain at a fixed position relative to the sensor, as would be the case in the above mentioned examples where the car with the sensor parks in front of and close to another car, or where the car is parked in a garage, the microprocessor will eventually ignore those objects (no longer set the FLAG_{ObjDetected} flag for the echo pattern associated with those objects). This occurs when the running averages of all the samples have fully adapted to the echo pattern, and as a result the sleep counter is programmed with the maximum delay amount. The result of this is that when objects are within the detection range of the sensor, the microprocessor won't continually execute the detection sequence at a high rate, as it does when it initially detects objects nearby. Instead, after the running average has adjusted to the echo patterns of any nearby objects, the microprocessor will slow the repetition rate to its slowest cycle rate and operate in a mode where minimum power is expended, ultrasonic excitations are issued at an infrequent rate, and only a default signal is communicated to the human interface device. It will continue in this mode of operation until it detects a change in the echo pattern, thus conserving power and not expending power on unneeded detection cycles.

Although embodiments of the invention have been described relating to the use of an ultrasonic transducer to sense the surroundings of the system using ultrasonic sound waves, other sensor types could be used successfully to sense characteristics of the system's surroundings. For example, motion detector technology could be used to sense characteristics of the surroundings. Some motion detectors sense changes in infrared activity in the surroundings. Other motion detectors use radar to sense changes in the patterns of radio frequency radiation reflected from objects in the environment. Still other motion detectors use photosensors to detect changes in the patterns of incident or reflected light as it is impacted by an object that has newly entered the environment near the detector. In each case the motion detector's sensor output could be sampled and processed to determine how soon a next measurement should be made and how long the sensor system can remain in a sleep state to conserve power. Other sensor technologies not associated with motion sensors could also be used in other embodiments of the invention. For example, a sensing system could send high frequency energy to an antenna to cause it to radiate electromagnetic radiation and then detect the characteristics of reflected electromagnetic energy. An optical sensor could be used to sense changes in light levels in certain regions in its field of view. In each case, the sensor is used to detect characteristics of the environment which can then be used to determine the duration of a sleep state or the rate at which further sensor measurements are made.

While the applicants have described the invention in terms of specific embodiments, the invention is not limited to or by the disclosed embodiments. It is to be understood that numerous modification and ramifications may be made without departing from the spirit or scope of this invention.

1. A method for controlling power consumption in a system that senses its surroundings comprising:
a. Sensing a physical property of the surroundings, and
b. Determining from the sensed physical property a duration of a sleep state.

2. The method of claim 1 wherein the duration of a sleep state is determined by comparing at least a first value derived from said sensed physical property to at least a second value derived from an earlier sensed physical property.

3. The method of claim 1 wherein the sensor is an ultrasonic transducer.

4. The method of claim 1 wherein the sensor is a motion detector.

5. The method of claim 1 wherein the duration of a sleep state is determined by a digital count value.

6. The method of claim 2 wherein the duration of a sleep state is determined to be longer if said second value is similar to said first value.

7. A system for repeatedly sensing its environment and operating in a low power consumption mode, comprising: a sensor, a power supply, an antenna and a control module wherein the control module uses a characteristic of a signal from the sensor to determine a rate at which to sense the environment.

8. The system of claim 7 wherein said characteristic of said signal is a similarity of a sensed result to a previously sensed result.

9. The system of claim 7 wherein the sensor is an ultrasonic transducer.

10. The system of claim 7 wherein the sensor is a motion detector.

11. The system of claim 7 wherein the rate at which the environment is sensed is determined by a digital timer.

12. The system of claim 7 wherein the power supply includes a battery.

13. The system of claim 7 wherein the power supply includes a solar cell.

14. The system of claim 7 wherein the antenna transmits a signal that is received by a receiver that is inside a vehicle.

15. A method for controlling an electronic device that senses the environment external to the device comprising at least the steps:
a. Sensing a characteristic of the environment external to the device,
b. Comparing a representation of the sensed characteristic with at least one stored representation of at least one earlier sensed characteristic of the environment, and
c. Changing from a first mode of operation to a second mode of operation depending on the result of said comparison.

16. The method of claim 15 wherein said first mode of operation operates at a different level of average power consumption than said second mode of operation.

17. The method of claim 15 wherein said first mode of operation operates with a different type of communication to a Human Interface Device than said second mode of operation.

18. The method of claim 17 wherein said Human Interface Device includes a display.

19. The method of claim 17 wherein said Human Interface Device includes an audio transducer.

20. The method of claim 15 wherein the at least one stored representation is a function of a plurality of earlier measurements.
